(19) United States
(12) Patent Application Publication
(10) Pub. No.: US 2007/0085456 A1
(43) Pub. Date: Apr. 19, 2007

(54) Display cabinet

(76) Inventor: Eddie George Farrens, San Antonio, TX (US)

Correspondence Address: JACKSON WALKER LLP, 901 MAIN STREET, SUITE 6000, DALLAS, TX, 75202-3797, US

(21) Appl. No.: 11/250,875

(22) Filed: Oct. 14, 2005

(51) Int. Cl. E06B 1/00

(52) U.S. Cl. 312/321.5

(57) ABSTRACT

A display cabinet for cabinetry merchandise having a center box unit, a primary side box unit, a secondary side box unit, and a base unit. The base unit may have one or more sample drawers. Within the box units may be displayed one or more product feature modules, including a functional sample door and various arrays of hardware and finishing samples.

### FIELD OF THE INVENTION

The present invention is generally related to cabinets for display of cabinetry merchandise and more particularly to portable display cabinets utilizing an inner sample door and various modules to display cabinetry merchandise.

### BACKGROUND OF THE INVENTION

Portable display cabinets are well known as being effective for the display and demonstration of merchandise to potential customers. Consumers are much more likely to purchase merchandise when they can see and feel the products firsthand. Vendors who travel or visit trade shows can take advantage of this fact by using portable display cabinets to impress consumers who otherwise might not visit primary store locations to view the products.

Home improvement companies face unique difficulties when attempting to display and demonstrate product samples for potential customers. The size and nature of the products being sold, such as doors, windows, and cabinets, makes it impossible for potential customers to view the merchandise without visiting a large warehouse-type store. Even then, the sheer number of possible selections and finishes makes it difficult to view all options. For this reason, the use of sample displays and partial product arrays have been particularly useful.

The difficulty, then, with the use of portable display cabinets for home improvement companies is the ability to adequately display a sufficient number of samples demonstrating a sufficient array of features. For example, cabinetry companies will want to be able to display samples of door styles, door finishes, shelf styles, and molding styles, while also being able to actively demonstrate the quality of the cabinet construction and display product information at the same time.

There is desired an improved display cabinet for cabinetry merchandise which allows for the display of multiple product samples and styles and the demonstration of product function and quality.

### SUMMARY OF INVENTION

The present invention achieves technical advantages as a display cabinet for cabinetry merchandise. The display cabinet enables demonstrations of functional features of various product selections as well as the physical mounting and display of various hardware and finishing choices.

The display cabinet comprises four main units: a center box unit, a primary side box unit, a secondary side box unit, and a base unit. The center box unit, the primary side box unit, and the secondary side box unit each comprise a rear panel surrounded by four sidewalls to create a shadowbox effect. Each box unit may then display one or more product feature modules. The feature modules may include functional sample doors, molding samples, door trim samples, and any other product features. The modules may be mounted directly to the rear panels of the box units or may be on hinged panels which rotate away from the rear panels for display and inward for storage. The base unit may contain one or more functional drawer samples. The side box units are connected to the center box unit by hinges. When the display cabinet is closed, the side box units pivot inward on their hinges to meet each other in the center and to face the center box unit, thereby hiding the contents of all units. When the display cabinet is closed, the footprint of the three box units falls directly upon and corresponds to the shape of the base unit so that the cabinet takes on a unitary rectangular shape.

### BRIEF DESCRIPTION OF THE DRAWINGS

FIG. 1 is a perspective view of the display cabinet; and

FIG. 2 is a perspective view of the display cabinet having multiple product feature modules.

### DETAILED DESCRIPTION OF THE PRESENT INVENTION

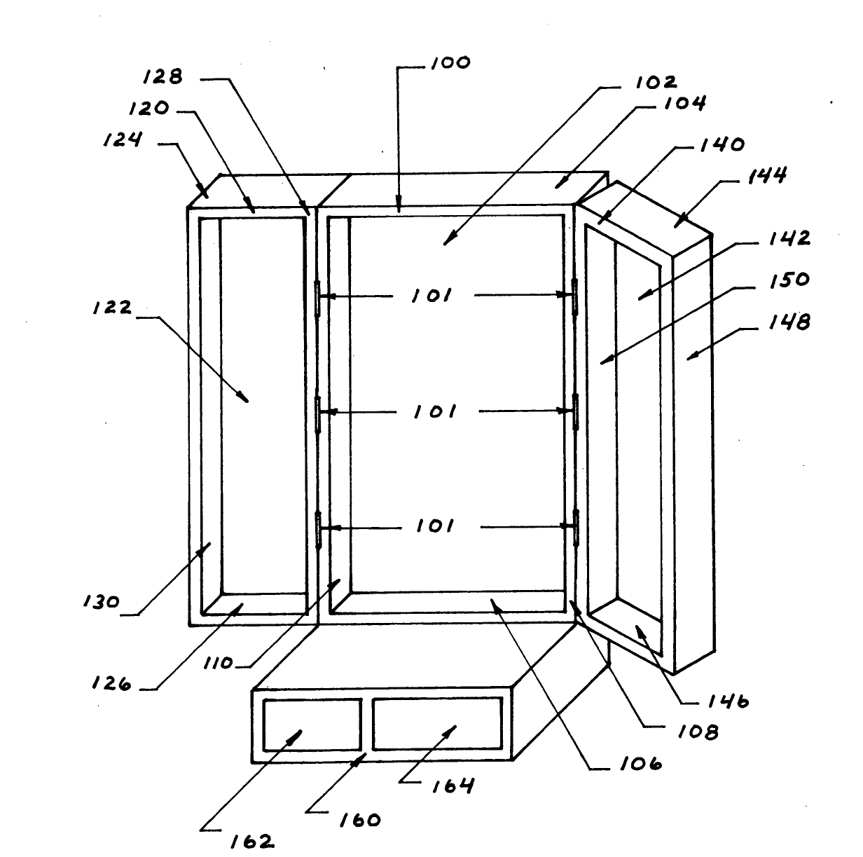

Referring now to FIG. 1, there is shown generally at 10 a display cabinet for cabinetry merchandise. The display cabinet 10 has a center box unit 100, a primary side box unit 120, a secondary side box unit 140, and a base unit 160. The primary side box unit 120 and the secondary side box unit 140 are pivotally connected to the center box unit 100 with hinges 101.

The center box unit 100 has a center rear panel 102, a center top sidewall 104, a center bottom sidewall 106, a center right sidewall 108, and a center left sidewall 110. The primary side box unit 120 has a primary rear panel 122, a primary top sidewall 124, a primary bottom sidewall 126, a primary right sidewall 128, and a primary left sidewall 130. The secondary side box unit 140 has a secondary rear panel 142, a secondary top sidewall 144, a secondary bottom sidewall 146, a secondary right sidewall 148, and a secondary left sidewall 150. On each of the box units, all of the sidewalls are connected to each other to form peripheral walls attached to the rear panels, which extend between the sidewalls. This creates a shadowbox effect in each box unit.

The base unit 160 is disposed beneath the central box unit 100. In this embodiment, the base unit 160 has a first sample drawer 162 and a second sample drawer 164. The sample drawers may be composed of varying materials and using different construction techniques to demonstrate product feature options to the consumers. The primary side box unit 120 and the secondary side box unit 140 can be rotated inward on hinges 101 until the primary left sidewall 130 is flush against the secondary right sidewall and the contents of all of the box units are hidden from view. At that time, the box units sit evenly above the base unit 160 so that the display cabinet 10 is closed in a unitary rectangular shape.

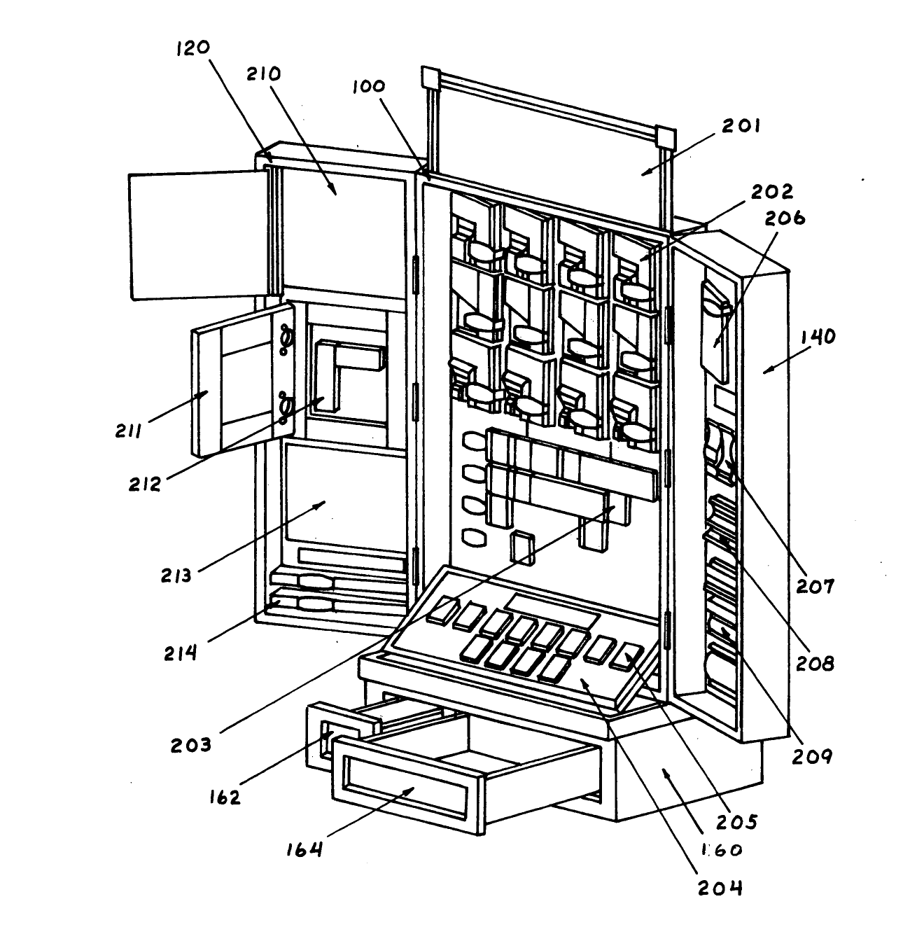

Referring to FIG. 2, one embodiment of the display cabinet 10 is shown to have various product feature modules. These modules may be arranged in any combination within the box units and are preferably mounted to the rear panels. All modules may be present in one display cabinet, or any fewer number of modules may be used at any one time in additional embodiments. In this particular embodiment, a sign 201 is located on top of the central box unit 100. Within the central box unit 100 is an array of door samples 202 and a first array of wood samples 203. At the bottom of the central box unit 100 is a flip panel 204 which will rotate and fold up within the central box unit 100. In this embodiment, a second array of wood samples 205 is located on the flip panel 204.

Still referring to FIG. 2, one or more product feature modules may also be located within the secondary side box unit 140. In this embodiment, the secondary side box unit 140 contains end panel samples 206, crown molding samples 207, trim molding samples 208, and base molding samples 209. One or more product feature modules may additionally be located within the primary side box unit 120. In this embodiment, the primary side box unit 120 contains a flip book 210 for displaying pages of product information, a functional sample door 211 which opens and closes, a drilling sample 212 for showing details of the drilling methods used during construction, an information panel 213, and shelf samples 214.

In further embodiments of the display cabinet, a closure mechanism, such as one or more magnets, may be attached to the side box units so that the entire cabinet is securely closed when the side box units are rotated inward. The display cabinet may also be designed as a portable unit having any kind of mechanism for movement, such as wheels attached to the base unit.

Though the invention has been described with respect to specific preferred embodiments, many variations and modifications will become apparent to those skilled in the art upon reading the present application. It is therefore the intention that the appended claims be interpreted as broadly as possible in view of the prior art to include all such variations and modifications.

What is claimed is:

1. A display cabinet comprising:
a center box unit having a center top sidewall, a center bottom sidewall, a center right sidewall, and a center left sidewall, and a center rear panel connected to and extending between said center sidewalls;
a primary side box unit pivotally connected to a first side of said center box unit having a primary top sidewall, a primary bottom sidewall, a primary right sidewall, and a primary left sidewall, and a primary rear panel connected to said primary sidewalls;
a secondary side box unit pivotally connected to a second side of said center box unit having a secondary top sidewall, a secondary bottom sidewall, a secondary right sidewall, and a secondary left sidewall, and a secondary rear panel connected to said secondary sidewalls; and
one or more product feature modules attached to one or more of said center rear panel, said primary rear panel, and said secondary rear panel,
wherein said one or more product feature modules includes a functional sample door.

2. The display cabinet of claim 1 further comprising a base unit connected to the center bottom sidewall of said center box unit having one or more sample drawers.

3. The display cabinet of claim 2 wherein said center box unit has at least two said sample drawers having different types of drawer hardware.

4. The display cabinet of claim 3 wherein the drawer hardware of one said drawer is stronger than the drawer hardware of another said drawer.

5. The display cabinet of claim 1 wherein said one or more product feature modules includes an array of door samples.

6. The display cabinet of claim 1 wherein said one or more product feature modules includes one or more arrays of wood samples.

7. The display cabinet of claim 1 wherein said center box unit further comprises a flip panel pivotally attached to said center box unit.

8. The display cabinet of claim 7 wherein one or more product feature modules are attached to the flip panel.

9. The display cabinet of claim 8 wherein one or more arrays of wood samples are attached to the flip panel.

10. The display cabinet of claim 1 wherein said one or more product feature modules includes end panel samples.

11. The display cabinet of claim 1 wherein said one or more product feature modules includes crown molding samples.

12. The display cabinet of claim 1 wherein said one or more product feature modules includes trim molding samples.

13. The display cabinet of claim 1 wherein said one or more product feature modules includes base molding samples.

14. The display cabinet of claim 1 wherein said one or more product feature modules includes a flip book.

15. The display cabinet of claim 1 wherein said one or more product feature modules includes a drilling sample.

16. The display cabinet of claim 1 wherein said one or more product feature modules includes an information panel.

17. The display cabinet of claim 1 wherein said one or more product feature modules includes shelf samples.

18. The display cabinet of claim 1 further comprising a sign attached to the center box unit.
